(19) United States
(12) Patent Application Publication
(10) Pub. No.: US 2023/0315463 A1
(43) Pub. Date: Oct. 5, 2023

(54) METHODS AND DEVICES FOR DEFEATING BUFFER OVERFLOW PROBLEMS IN MULTI-CORE PROCESSORS

(71) Applicant: Forrest L. Pierson, Dallas, TX (US)

(72) Inventor: Forrest L. Pierson, Dallas, TX (US)

(21) Appl. No.: 18/164,122

(22) Filed: Feb. 3, 2023

Related U.S. Application Data
(63) Continuation of application No. PCT/US2023/061922, filed on Feb. 3, 2023.
(60) Provisional application No. 63/324,953, filed on Mar. 29, 2022.

(51) Int. Cl. G06F 9/30

(52) U.S. Cl. CPC G06F 9/30178

(57) ABSTRACT

Disclosed herein are methods and devices for defeating buffer overflow problems in multicore processors. In one embodiment, a processor implemented within a multicore processor integrated circuit (IC) is disclosed. The processor includes an instruction register and selection circuitry including a hardware latch operable to thwart a buffer overflow attack. The selection circuitry is electrically coupled with the instruction register. The selection circuitry is configured for: providing decrypted instructions to the instruction register when the hardware latch is in a first state and providing un-decrypted instructions to the instruction register when the hardware latch is in a second state. The coupling of the selection circuitry can be directly to the instruction register of a processor core, or indirectly by directing the output of the selection circuitry to cache memory inside the processor IC so that the instruction register only receives decrypted instructions from the cache memory.

### CROSS-REFERENCE TO RELATED APPLICATION

This application is a continuation application of PCT Patent Application No. PCT/US2023/061922 (Attorney Docket No. 347/7 PCT) filed on Feb. 3, 2023, titled “METHODS AND DEVICES FOR DEFEATING BUFFER OVERFLOW PROBLEMS IN MULTI-CORE PROCESSORS,” which claims priority to U.S. Provisional Patent Application No. 63/324,953 (Attorney Docket No. 347/7 PROV) filed on Mar. 29, 2022, titled “METHOD AND TECHNIQUE FOR DEFEATING BUFFER OVERFLOW PROBLEMS IN MULTI-CORE PROCESSORS,” the entire contents of all of which are incorporated herein by reference.

### TECHNICAL FIELD

The present disclosure relates to digital processors. More particularly, the present disclosure relates to network attachable digital processors.

### BACKGROUND

Traditional digital processors (processor) are complex logic devices that execute user instructions in a sequential fashion to produce a desired result for the user. Referring to FIG. 1, these instructions are stored in a Memory 101, and are read from Memory 101 and executed by the processor. Instructions differ from other instructions by the sequence of bits inside the instruction. Each bit can assume one of two states, providing two possible outcomes. One state is arbitrarily called a ‘zero’ state, often represented by the number ‘0’, and the other state is called a ‘one’ state, often represented by the number ‘1’. Other nomenclature may be used to describe these two states, including but not limited to terms such as ‘on’ and ‘off’, ‘set’ and ‘clear’, or ‘high’ and ‘low’. There are also technologies that can encode three or more states into a single bit of information, however, at present the state of the art in electronics needed to implement three or more states in a bit is of sufficient complexity and size that it takes fewer transistors to implement two bits of two states each (which can provide up to four possible states between the two bits) than it does to implement a single bit with three or four states. Regardless of whether the bits in an instruction represent two states each, or more than two states each, each instruction is defined by the state of each bit and the order with which the bits are placed in the instruction.

One of the more novel features processors can provide for society is the ability to electronically control the flow of large quantities of data through a communications network called the World Wide Web or the Internet. The Internet today has become so intertwined with society that, for example, it is now used to do searches for information that used to take people hours, days, or even longer to perform by hand. The Internet is also used to process the transfer of funds and other banking services, engage in on-line shopping, send and receive pictures, books or papers, pre-recorded or live video, music, and sound, and control much of society's utility infrastructure.

Sadly, there are people who seek to malevolently take control of processors connected to the Internet, a Local Area Network (LAN), via IEEE 802.11 (that is, Wireless Fidelity [Wi-Fi]), Cellular Mobile Data, Direct Connection, or any other means of connecting a processor to a potentially hostile entity, to disrupt commerce, engage in acts of theft, vandalism, sabotage, or revenge, inconvenience people or disrupt their lives, or even endanger people and damage society's infrastructure by changing the sequence of instructions inside a processor's Main Memory 101a. Other potential sources of inserting malicious code into a processor system include: 1) a user directly connecting an external disk drive or flash drive to a processor with malicious code on it that can be automatically executed or manually executed by the user, typically when authorized to do so by the processor, 2) opening malicious email, again typically when authorized by the processor, 3) clicking on links in a web browser that download malicious code, typically when authorized to do so by the processor, 4) other means of bypassing the operating system's code screening and installation procedures, including code setting up a buffer in executable memory that execution will flow into and then filling the buffer with malicious code after the program has been installed by the operating system.

The new sequences maliciously placed in processors' Main Memory 101a can instruct equipment that controls society's utilities to engage in damaging behavior, violate safety protocols (and thus endanger people or the environment), compromise personal, privileged, or classified information, shut down utilities, improperly move funds around, or by taking over a sufficient number of processors, instruct them to simultaneously send service requests to overwhelm other processors and shut them down. If the disruption is to processors controlling society's infrastructure and the disruption is successful at shutting down something such as electrical power, if not restored soon chaos could result, plunging society into anarchy.

To mitigate the hostile takeover of processors, a series of protective responses have been developed. These responses include firewalls, which are specialized processors designed to recognize invalid attempts to pass Internet traffic from the unprotected Internet to a protected localized network and block such traffic.

Another product is a Gateway, which changes, or translates, the Internet addresses of processors inside a protected local network before the request goes to the unprotected Internet. The Gateway was initially invented in part to help circumvent the shortage of Internet Protocol addresses on the Internet by isolating a private network from the Internet. The private network could then contain tens of thousands of Internet Protocol addresses also in use on the Internet, even if the Gateway only had a handful of addresses on the Internet side. When a request for an Internet connection came through the Gateway from the protected side, it would translate the internal address on the private network into a public Internet address on the unprotected side and send the request out, keep track of the transaction so that when it returned the Gateway would re-translate the address back to the private network address, and send the results back to the private network for routing. As a result of this function, the Gateway hid the structure and real addresses of the private network from the Internet. Thus, malicious parties on the unprotected Internet do not know the true nature of the structure of the protected local network. Further, if the Gateway receives a request to communicate with a processor it doesn't have a record of asking for such a communication, it stops the communications attempt (many firewalls also perform this function).

Other attempts at mitigating the hostile takeover of a processor, called a virus scanner, place specialized software on the processor that scans all Internet, LAN, Wi-Fi, cellular mobile data, direct connection, or any other means of connecting a processor to a potentially hostile data sourced traffic going into it for patterns of behavior that are inappropriate or malicious code and stop them prior to being acted upon.

Most methods of mitigating hostile attempts to take over network connected processors have been so successful that only one method still remains, the ‘Buffer Overflow Attack’. See “Tools for Generating and Analyzing Attack Graphs” by Oleg Sheyner and Jeannette Wing, Carnegie Mellon University, Computer Science Department, 5000 Forbes Avenue, Pittsburgh, PA 15213, published in 2004, referencing page 357, FIG. 4 and the text between it and the start of section 4.2. Per the specified text in this paper, a properly configured and resourceful firewall will be sufficiently successful at stopping malicious internet, LAN, Wi-Fi, cellular mobile data, direct connection, or any other means of connecting a processor to a potentially hostile entity type of intrusions that only a Buffer Overflow Attack (BOA) will succeed in taking control of processors protected by the firewall. This makes the BOA a prime source of attacks on firewall or gateway protected processors.

The BOA utilizes a weakness in the ‘C’ programming language (and several other computer languages). This weakness is that when a buffer in Main Memory 101a is set aside to temporarily hold incoming data (typically from the Internet, LAN, Wi-Fi, cellular mobile data, direct connection, or any other means of connecting a processor to a potentially hostile entity), the programming language does not provide for a check to determine if the incoming data exceeds the buffer's size, overflowing it. An analogy would be to fill a glass with water on a restaurant table from a pitcher and not stop pouring water when the cup is full, spilling water all over the table as a result. Thus data written to the buffer could accidently, or maliciously in the event of a BOA, overflow past the boundary of the buffer and overwrite instructions in adjacent block of instructions in Main Memory 101a. If the data is actually malicious code intended to take control of the processor, and the Main Memory 101a adjacent to the buffer that is overflowing contains executable code, then the well behaved code will be overwritten by malicious code. The next time the code in the overflowed Main Memory 101a is executed, the processor becomes compromised.

Attempts to mitigate the BOA, such as logically separating blocks of Main Memory 101a so that locations where executable code reside is not always adjacent to incoming buffers, have been implemented. All of these attempts have reduced, but not eliminated BOAs. A different approach that provides a reliable means of stopping BOAs is needed.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

In at least one embodiment, a digital processor includes: all the necessary components of a traditional digital processor, including a Processor Memory Interface (PMI) 105, Instruction Register (IR) 103, a set of Processor Registers 106 for storing temporary values including a Program Counter 106a (PC), a section of logic to decode instructions called the Instruction Execution Circuitry (IEC) 102, an Arithmetic Logic Unit (ALU) 107 to perform mathematical and logical operations on data, and special bits called Flags 108 that store the processor state as well as the results of logic and mathematical operations of the previous instruction(s) for the purpose of providing the IR 102 with the means of making the correct decision as to whether or not perform a conditional branch or jump operation; said processor containing additional components to store a Seed Value in a Command Encryption Register (CER) 202 that instructs a bit modification circuit to change bit states and/or positions of bits in an instruction before it goes into the IR 102, plus the bit modification circuit (decryption circuit 201b) capable of modifying bit states and/or bit positions before an instruction is stored into the IR 103, and a means of selecting the output of the decryption circuit 201b or bypassing the decryption circuit 201b while placing instructions in the IR 103, and a latch 205 that selects between the output of the decryption circuit 201b or bypassing the output of the decryption circuit 201b; said decryption circuit 201b designed to modify instructions at a sufficient rate that it will not slow the processor down; said latch 205 can only be changed to bypass the decryption circuit 201b by a processor reset, and changed to select the decryption circuit 201b by an instruction that is decoded by the IEC 102 to do so; and said instruction that changes the latch to select the Decryption Circuitry will optionally change the value in the PC 106a to point to a different part of memory for code execution, and if the processor also contains Cache 101c, declare the contents of Cache 101c invalid so any unencrypted instructions in the Cache 101c will no longer be executed.

In at least one example, the digital processor further includes a second bit modification circuit (encryption circuit 201a) that will utilize the same Seed Value used by the decryption circuit 201b to take an instruction and modify it such that when said modified instruction is passed through the decryption circuit 201b it will be returned to its original value; said encryption circuit 201a containing a latch that is written to by the processor with an unmodified instruction and read out with an encrypted instruction that is to be stored in memory for later execution. This means of generating encrypted instructions is mentioned only as an example, there are other means that can be used to encrypt instructions which are equally viable. This means mentioned here was not intended to limit the scope of this claims of this patent.

In at least one example, the digital processor further includes a random number generator capable of generating the Seed Value that can be placed in the CER 202 such that the processor does not have access to the Seed Value to prevent the unintentional disclosure of the Seed Value.

In at least one example, the digital processor further includes a Cache 101c to reduce the wait time for reading instructions or data from memory for commonly used instructions or data, where the Cache 101c contents will all be declared invalid when the instruction that changes the latch 205 to select the Decryption Circuitry and optionally the value of the PC 106a is executed, as all instructions stored in Cache 101c at the time the latch 205 is changed are unencrypted and will be turned into senseless, random code when they pass through the decryption process By declaring the cache 101c contents invalid, the processor will have to re-fill the cache with encrypted instructions that when they pass through the decryption process produce a coherent, logical, and meaningful sequence of instructions.

In at least one example, the digital processor further includes a latch 205 that selects between decrypted instructions and un-decrypted instructions after having been set to select decrypted instructions, including a means of: allowing the IEC 102 to select between decrypted instructions and un-decrypted data read from memory through the PMI 105 to be placed in one of the Processor Registers 106, the Flags 108, or the ALU 107; wherein the IEC 102 shall always select decrypted instructions when placing immediate data into one of the Process Registers 106, the Flags 108, or the ALU 107, or instructions that provide modifications to an indexed address, or an extended address. Immediate data, modifications to an indexed address, and extended addresses are data that is part of the flow of instructions and is read out of memory 101 (Main Memory 101a, boot code 101b, or Cache 101c) by the PC 106a.

In at least one example, the digital processor further includes two separate internal processor data busses 104, one said busses carrying decrypted information from the PMI 105 and the other one of said busses carrying un-decrypted information from the PMI 105, the purpose for which is to: allow the IEC 102 to choose whether to store decrypted information or un-decrypted information into a Processor Register 106, the input to the ALU 107, or Flags 108; thereby allowing the processor to encrypt all instructions stored in Main Memory 101a without having to determine which instruction is meant for the IR 103 and which instructions are meant for other destinations in the processor including the Processor Registers 106, ALU 107, or Flags 108, thereby allowing the Boot Code 101b as well as those portions of the software operating system that load encrypted instructions into Main Memory 101a the ability to do so without having to determine whether or not the instruction is intended solely for the IR 103.

In at least one example, the digital processor contains multiple different encryption/decryption algorithms within the encryption and Decryption Circuitry 201: allowing the printed circuit board (PCB) manufacturer to use an external serial programmable read-only memory to store a configuration selection that randomly selects a small subset of the encryption/decryption algorithms in a PCB-by-PCB basis, so that malevolent users by being aware of the lot number or date of manufacture of a PCB cannot determine which algorithm is used; the serial programmable read-only memory can be programmed by a bed-of-nails tester or other PCB verification tool to load different configurations; and the serial programmable read-only memory can be optionally configured so that its contents cannot be modified unless it is connected to a PCB verification tool.

A method is provided for changing a processor instruction randomly, covertly, and uniquely, so that the reverse process can restore it faithfully to its original form, making it virtually impossible for a malicious user to know how the bits are changed, preventing them from using a buffer overflow attack to write code with the same processor instruction changes into said processor's memory with the goal of taking control of the processor. When the changes are reversed prior to the instruction being executed, reverting the instruction back to its original value, malicious code placed in memory will be randomly altered so that when it is executed by the processor it produces chaotic, random behavior that will not allow control of the processor to be compromised, eventually producing a processing error that will cause the processor to either shut down the software process where the code exists to reload said compromised code, or the processor is reset.

In at least one example, the method used to encrypt software in the computer's Main Memory 101a or Cache 101c, since there is near-zero feedback to a malicious user on the success or failure of a BOA attack, also lends itself to encrypting user data in Main Memory 101a or Cache 101c. Frequently computers store large amounts of privileged user data (proprietary corporate data, HIPPA protected medical data, International Trafficking in Arms Regulations (ITAR) or Export Arms Regulations (EAR) data, etc.) or even classified data in mass storage devices such as rotating disk drives or solid-state disk drives. While stored on the mass storage device, a powerful per-user encryption method such as AES-256 or equivalent or better can be employed to protect the data from malicious access, but when loaded into the computer's Main Memory 101a it becomes vulnerable to disclosure. As typically at most only one process at a time may open an encrypted file on a mass storage device for writing, the process would generate a security key to encrypt the user data when written to Main Memory 101a or Cache 101c, and decrypt it when read from Main Memory 101a 110a or Cache 101c inside the processor IC. As the security key for each process would be randomly generated the odds are extremely high that no two processes would have the same key, thus the user data they open would be protected from examination by any other process running on the same computer or systems of computers. Each time the process needs to access data memory it will send a copy of its security key to the encryption/decryption engine 602, which once the transfer is complete deletes its copy of the key. Once through with the data the file on the mass storage device would be closed and the security key discarded. Any remnants of the user data left in Main Memory 101a would still be encrypted and therefore unreadable by any other process as the key is no longer available, however, the processor's Memory Management Unit (MMU) should be instructed to immediately over-write this memory to eliminate the old contents before re-assigning this memory to another process.

In at least one example, the encryption and decryption process can take place between the Cache 101c and processor itself. In this instance, the Cache and cache & predictive branch controller must be able to read encrypted instructions in the Cache 612 so that it can work to ensure both potential destinations of a branch instruction are contained within the Cache 612 closest to the processor Core 613 within the processor Integrated Circuit (IC) 601 to minimize the odds of a cache miss, a cache miss meaning that the instruction is not in the Cache 612 and therefore the Processor Core 612 must wait until the desired instruction is placed in the Cache 612 closest to it.

In at least one example, the encryption and decryption process can take place between the External Memory Interface 602 and the Cache 610, 611, 612.

In at least one example, in processor ICs 601 with more than one level of Cache 101c, the encryption and decryption process can take place be any two levels of Cache 610, 611, or Cache 611, 612, or any other combination of various levels of Cache 101c as desired by the IC architect. Note that this example does not preclude a processor IC 601 having only three levels of Cache 610, 611, 612 within it, but the example shown in this description is only limited to three levels of cache for simplicity of illustrating the concept only. Some processor IC 601 designs may have fewer levels of Cache 101c, others may have more.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 depicts an embodiment of the prior art.

FIG. 2 depicts an arrangement according to at least one embodiment.

FIG. 3 depicts an enhanced example of the embodiment in FIG. 2.

FIG. 4 depicts a more enhanced example of the embodiment in FIG. 3.

FIG. 5 depicts a simplified example by which, when multiple algorithms may exist, how to instruct the processor IC to use only a limited set of such algorithms in accordance with embodiments of the present disclosure.

FIG. 6 depicts a partial block diagram of a processor integrated circuit with multiple Processor Cores and multiple levels of Cache memory in accordance with embodiments of the present disclosure.

### DETAILED DESCRIPTION

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Functional implementations according to one or more embodiments are illustrated in the drawings. The following definitions may be used in the drawings and in these descriptions:

Boot Code Instructions executed by a processor when it first comes out of reset. Boot Code 101b has the privilege of always being stored in a non-volatile memory that cannot be modified by malicious users (in a properly designed processor), which always allows a processor to come out of reset in a known state.

Encryption Algorithm Specially designed hardware logic or a sequence of processor instructions that modifies the contents of a new instruction being stored to memory so that when it is decrypted it will be returned to its original value.

Decryption Algorithm Specially designed hardware logic or a sequence of processor instructions that modifies the contents of an encrypted instruction so that it is returned to its original value. Note that decryption step does not involve writing decrypted instructions back to memory, so the memory contents remain encrypted even after being read. The sequence of processor instructions that modifies an encrypted instruction so that it is returned to its original value will typically be disabled by people developing and debugging code, whereas the specially designed hardware logic would do so automatically and in real time during normal processor execution to provide the actual protection from a BOA.

Seed Value A randomly generated number that determines how an encryption algorithm is used to encrypt instructions, and how a decryption algorithm is used to decrypt instructions.

Non-volatile Memory Memory whose contents are preserved when power is removed.

Volatile Memory Memory whose contents are not preserved when power is removed.

Cache A small memory that is usually internal to the processor IC, but is much, much faster to access than most external volatile or non-volatile memory. Usually cache is located inside the same integrated circuit that the processor is located in. Because of its high access speed, Cache will cost more. However, due to its small size, the cost impact is trivial. Special logic is used to control Cache so that its contents will mirror the contents of the most commonly accessed portions of Main Memory 101a or Boot Code 101b. When a memory access to Main Memory 101a or Boot Code 101b is to a section that is mirrored in the Cache, the Cache is used rather than the Main Memory 101a or Boot Code 101b, reducing the wait time by the processor and speeding it up. This is often times called a cache hit. When a memory access to Main Memory 101a or Boot Code 101b is to a location that is not mirrored in Cache, then the processor must wait while the Main Memory 101a or Boot Code 101b responds. This is often times called a cache miss. During a cache miss, the logic managing the Cache will determine which part of Cache has been used the least in recent accesses and overwrite it with the contents of the Main Memory 101a's or Boot Code 101b's latest access to increase the chances of more cache hits in the future. When Cache contents are declared invalid, then they must be reloaded from Main Memory 101a or Boot Code 101b to be considered valid again.

Cache Hit An instruction or data needed by the processor is in a cache 101c and therefore can get into the processor itself sooner, increasing processing throughput and speed of operation.

Cache Miss An instruction or data needed by the process is not in a cache 101c, therefore it must be brought into the cache by a more remote cache or Main Memory 101a, which takes longer and thus the processor has to wait, reducing processing throughput and speed of operation.

Main Memory The bulk of a processor's memory, usually located outside the integrated circuit the processor is located in.

Read Only Memory A non-volatile memory whose contents cannot be modified.

Inter-Integrated Circuit A protocol that uses a minimum number of pins to transfer data between a master device such as a processor and a slave device such as a memory chip.

Exception An interrupt to a processor caused by an undefined or illegal instruction, or unauthorized access to a memory location. Properly written code will not generate exceptions. Malicious code that was decrypted and as a result is turned into random, chaotic instructions will eventually create an exception.

Indexed Address An address pointing to a location in memory that uses a Processor Register 106 to provide a base value. As the Processor Register 106 is incremented or decremented after each access, the memory location for the next access changes without having to modify the instruction itself. This is useful for reading or writing data from or to adjacent memory locations, such as in a temporary data buffer.

Extended Address An address that points to a location in memory that is not referenced to a Processor Register 106. This is useful for accessing the start of instructions in a Boot Code 101b, or for input and output devices such as disk drives, whose addresses do not change.

Immediate Data Data that is part of an instruction. For example, assume a certain command must be written to a disk drive in order for it to spin up before files can be read from or written to it. As an example, an immediate data value will be loaded into a Processor Register 106 by an instruction, followed by another instruction which writes the Processor Register 106 containing the immediate data to the disk drive controller. The immediate data will contain a command that tells the disk drive to spin up so it can be accessed.

The following acronyms may be used in drawings and in these descriptions:
ALU Arithmetic Logic Unit
BOA Buffer Overflow Attack
EDC Encryption and Decryption Circuitry
CER Command Encryption Register
EDC Encryption and Decryption Circuitry
IC Integrated Circuit
I²C Inter-Integrated Circuit
IEC Instruction Execution Circuitry
JOP Jump On Program
NVM Non-Volatile Memory
PCB Printed Circuit Board
PMI Processor Memory Interface
OS Operating System
RNG Random Number Generator
ROP Return On Program
RTS Return from Subroutine
RTI Return from Interrupt

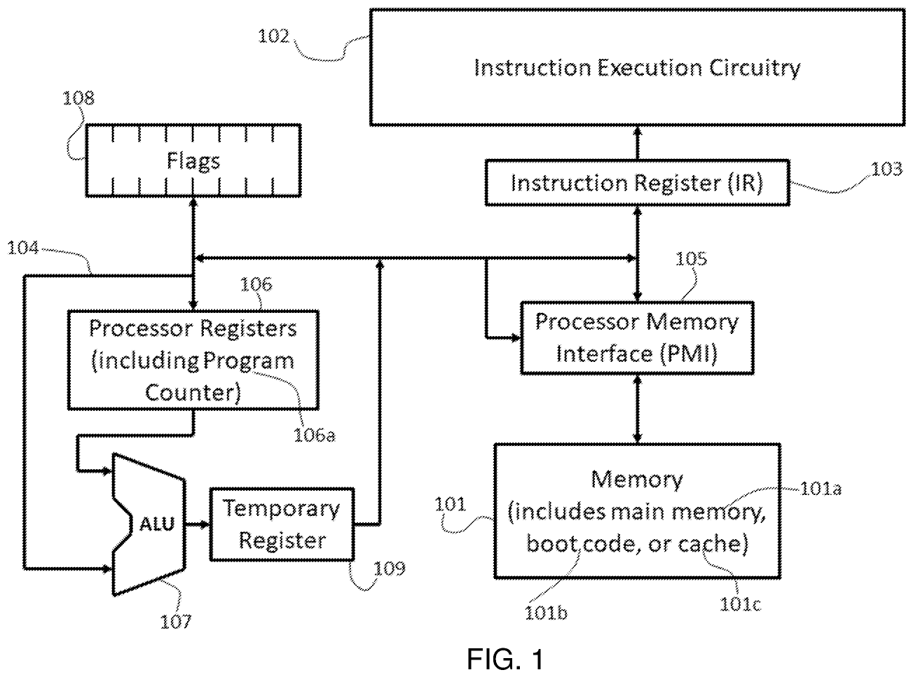

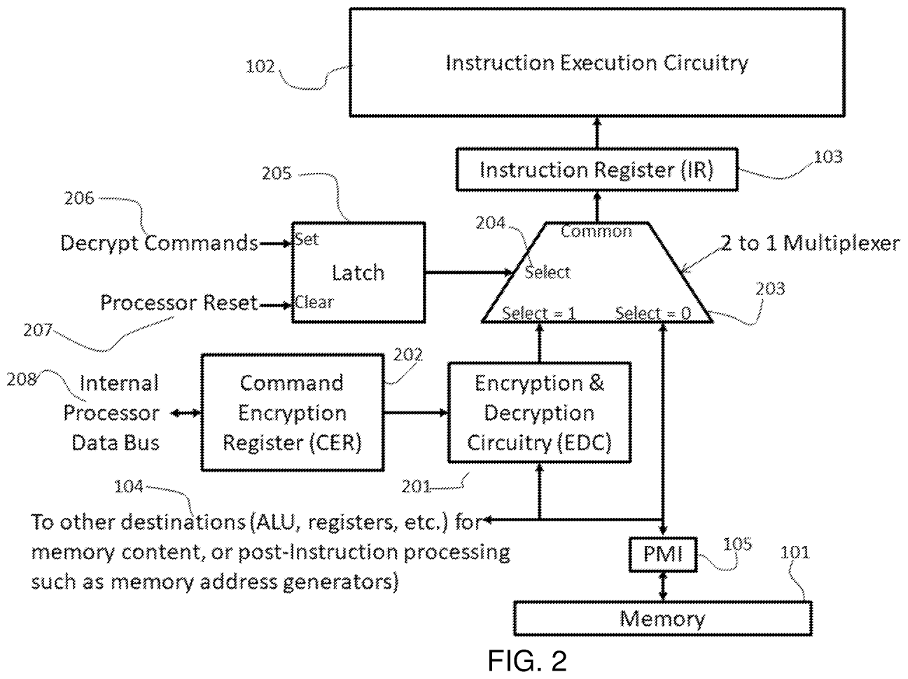

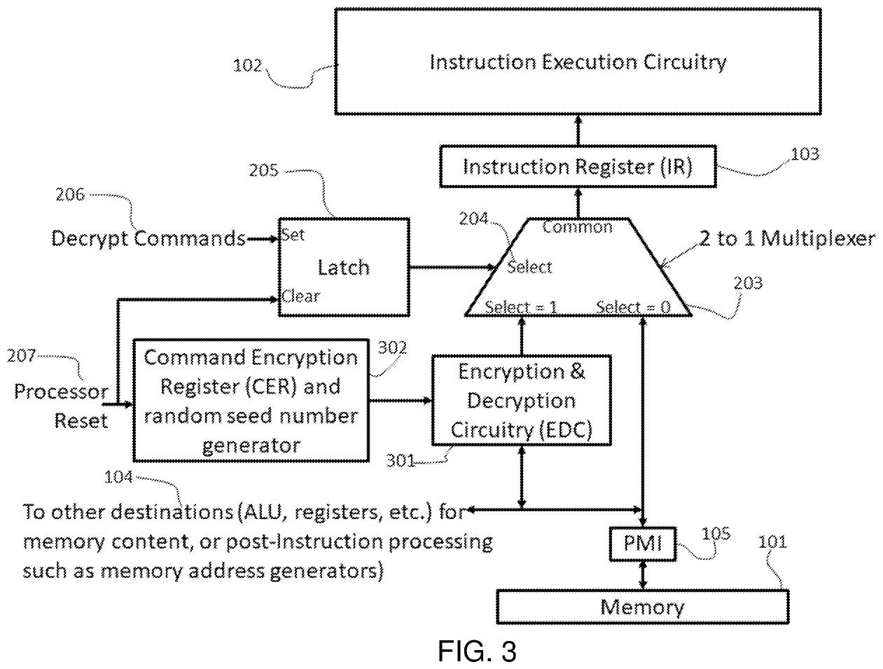

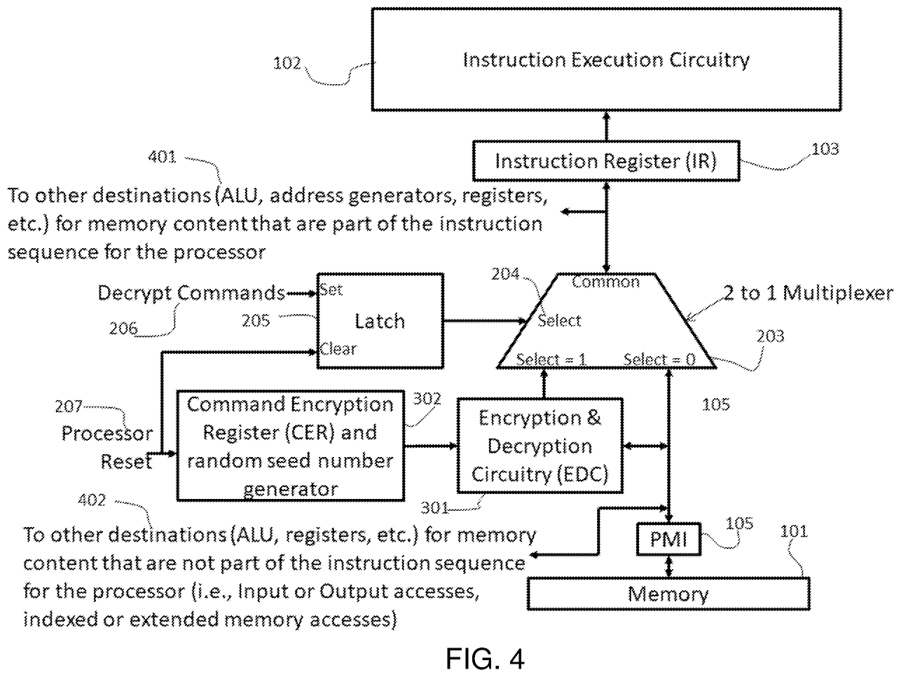

Instructions are read from Memory 101 (see FIG. 1, FIG. 2, FIG. 3, or FIG. 4) by a Program Counter 106a, which is one of several Processor Registers 106 (see FIG. 1) inside the processor. The Program Counter 106a is the register that points to where the next instruction will reside in Memory 101. As the instruction is read from Memory 101, it is placed in a holding register called the Instruction Register 103 (IR). The IR 103 holds the instruction so that the Instruction Execution Circuitry 102 (IEC) can decode the instruction and issue commands to the processor's Arithmetic Logic Unit (ALU) 107, Processor Registers 106, Flags 108, a Temporary Register 109, the IR 103, and the Processor's Memory Interface 105 (PMI). Data or addresses flow between the different elements of a processor over an Internal Processor Bus 104. Flags 108, which represent certain processor states and priority levels as well as the status of certain results from the execution of previous processor instructions, are changed as a result of an ALU 107 operation or an instruction. The Flags 108 may influence the results of subsequent ALU 107 operations and will influence the sequence of conditional branch instructions (a conditional branch instruction will change the value of the Program Counter in one of two ways, depending on which condition is specified and the state of the Flags 108, for example, “Branch if Zero” means that if the Zero Flag is set, indicating the previous ALU instruction ended up with a result of zero, then the Program Counter is changed to some value other than the next instruction, while if the Zero Flag is clear, then the Program Counter continues to go to the next instruction after the “Branch if Zero” instruction). The Temporary Register 109 is a register that is not referenced directly in any instruction from Memory 101 but is used by the IEC 102 to temporarily hold ALU 107 results until another register, either one of the Processor Registers 106, the Flags 108, the ALU 107, or the PMI 105 can accept it.

The arrangement shown in FIG. 1 is a representative typical arrangement of registers and logic inside a processor and is not to be construed as limiting the scope of the claimed subject matter. Note that for clarity, the Processor Registers 106, ALU 107, Flags 108, and Temporary Register 109 are not shown in FIG. 2, FIG. 3, and FIG. 4 although they can be assumed to be represented in all of them by the presence of the Internal Processor Bus 104 in FIG. 2 or FIG. 3, or a pair of specialized Internal Processor Busses 401, 402 in FIG. 4. Also note that in the processor architecture shown in FIG. 1 all addresses needed by the PMI 105 may be generated for the processor utilizing the Temporary Register 109 and do not require separate address generation circuitry. This architecture is not to be construed as limiting the scope of the claimed subject matter. There are other processor architectures that utilize dedicated circuitry to generate addresses for Memory 101 that also fall within the scope of the claimed subject matter.

The sequencing of the commands from the IEC 102 implements the instruction and provides for the desired outcome of the instruction. Succeeding instructions are read sequentially from Memory 101 and executed in sequence, providing a deterministic outcome that can repeat itself over and over again with a very, very high degree of reliability. This high reliability and repeatability has lead to the use of processors to control and implement much of the more tedious and boring tasks in society, as well as provide new features that a generation or two ago were inconceivable.

At least one embodiment (see FIG. 2) provides a method of encrypting the instructions before they are placed in a Memory 101 called Main Memory 101a. Main Memory 101a is read/write Memory 101 where the operating system, processes working under it, and data for the process(es) reside while the processor is operating. The encryption algorithm is seeded by a randomly generated number called the ‘Seed Value’ whenever a processor comes out of reset. Ideally the Seed Value will be different each time the processor comes out of reset. The Seed Value is not made known outside of the processor. Boot Code 101b instructions, which are instructions that start up a processor after it has been reset, will use a random number generator algorithm or a random number generator function in the processor to randomly create the Seed Value. The Seed Value is then stored in a Command Encryption Register 202 (CER). The Seed Value will be used to change a combination of bits in the instruction into different values, a unique and different value for each possible value the instruction can assume. Subsequently, when the Boot Code 101b begins to load the processor's operating system into Main Memory 101a from a mass storage device such as a disk drive, it takes each instruction and encrypts it with the encryption algorithm controlled by the Seed Value that was previously placed in the CER 202. After the instruction is encrypted, it is then stored in Main Memory 101a. Note that to use this embodiment, the processor must know which values written to Main Memory 101a are intended for the IR 103 or are considered immediate data, and which values written to Main Memory 101a are intended to go to the ALU 107, the Flags 108, or Processor Register 106, so that it will only encrypt those commands intended for the IR 103 or immediate data.

Once enough of the operating system has been stored in Main Memory 101a for it to take over, the Boot Code 101b will simultaneously 1) instruct the processor to start executing code from Main Memory 101a where the operating system has been stored and 2) sends the Decrypt Command 206 to a Latch 205 (see FIG. 2, FIG. 3, or FIG. 4). The output of Latch 205 drives a Select input 204 into a “2 to 1 Multiplexor” 203 (Multiplexor) in FIG. 2, FIG. 3, or FIG. 4, that will select decrypted instructions from the Encryption & Decryption Circuitry 201 (EDC) in FIG. 2 or EDC 301 in FIG. 3 or FIG. 4 to go into the IR 103. The IEC 102 will instruct the IR 103 when to store a value on the Internal Processor Bus 104 (FIG. 1) or the common output of the Multiplexor 203 (FIG. 2, FIG. 3, or FIG. 4) into itself, so that it won't accidentally store other data that may be present on its inputs.

Once instruction decryption begins, Latch 205 cannot be switched back to selecting un-decrypted instructions except by a processor reset 207. This is necessary as all instructions in Main Memory 101a are now encrypted and must be decrypted each time they are read of out of Main Memory 101a before being sent to the IR 103, as decrypted commands are not written back out to the Main Memory 101a. By also making it impossible to turn decryption off by a command, malicious code would be unable to change the processor back over to its more vulnerable state where a BOA could become successful.

The method of how the processor selects decrypted instructions or un-decrypted instructions must be such that when the Latch 205 is set it always selects decrypted instructions, and when Latch 205 is not set (that is, it is in a clear state after a reset), it always selects un-decrypted instructions. As an example of how this is accomplished, in FIG. 2, FIG. 3, or FIG. 4 a Multiplexor 203 is shown implementing this needed feature. The Multiplexor 203 is shown as an example of how this function is implemented, and does not limit the scope of the claimed subject matter to using only a Multiplexor 203. Other methods of selecting decrypted instructions when Latch 205 is set or un-decrypted instructions when Latch 205 is clear are within the scope of the claimed subject matter, for example, the seed value is masked off so that no changes to the bits in the instruction or immediate data occur as these pass through the IEC 102.

Because the instructions stored in Main Memory 101a are now encrypted and the Seed Value is unknown to the outside world, malicious users will have to guess at what the Seed Value is, and perhaps even the encryption algorithm. If the malicious user guesses wrong, then when the malicious code placed in Main Memory 101a is decrypted, it isn't turned into the desired instructions. Instead it is turned into random, unpredictable values. The unpredictable instructions produce chaotic results. Because the results are chaotic and do not produce a deterministic result, the processor will not be taken over by the malicious user. Eventually the random, chaotic results will generate an ‘exception’, which is an interrupt to the processor caused by misbehaving code. The exception handler code in the processor will know what part of Main Memory 101a the code was being executed out of when the exception occurs, and will compare its contents (after decrypting it) with what should be there. If there is a difference, the processor will assume it has suffered a BOA and either 1) stop the process that resided in the compromised block of Main Memory 101a, and reload it, or 2) reset itself.

Note that each reset should generate a different random number for the Seed Value. Hence the malicious user will not know if a previously unsuccessful guess would have actually been the new Seed Value; in other words, after a processor reset, the malicious user will have to start all over again trying to guess what the Seed Value is. Frequently the malicious user will also be unaware of when a processor targeted by the malicious user is reset, further adding to the uncertainty facing the malicious user.

Since the feedback mechanism between implementing the BOA and determining if the results are successful is extremely slow, an encryption algorithm that implements a reasonably large number of different permutations would take many decades for the malicious user to successfully guess at the correct algorithm. The net result is that the malicious user will tire of their efforts to take control of the processor and stop their BOA attacks. Further, by resetting the processor on a periodic basis or after several unsuccessful BOA attacks have been detected, any past record of known guesses as to what the Seed Value is, but now known to not be the correct seed value, by a malicious user are rendered useless because after a reset the Seed Value will be different, and in fact could be that one of those past attempts would now be the new Seed Value. The malicious user would have to start over again, but due to the nature of their being unsuccessful in implementing a BOA attack, they would have difficulty even knowing that their targeted processor was reset and thus requiring them to start over again, further frustrating their efforts.

In at least one embodiment, the Encryption and Decryption Circuitry 301 (EDC) in FIG. 3 or FIG. 4 is used to encrypt commands before writing them to Main Memory 101a, saving the processor of the job of having to do so. A further advantage of this is that if the CER 302 also contains a random number generator in it that generates the Seed Value without assistance from the rest of the processor, then the rest of the processor is not aware of the encryption algorithm or Seed Value, further enhancing security. In this embodiment, after a Seed Value is stored in the CER 202, an unencrypted instruction is then written to the EDC 301 to be encrypted. The encrypted instruction is read out of the EDC and written to Main Memory 101a. For processors sold on the open market, keeping the details of the encryption algorithm and Seed Value secret from the processor will make BOA attack attempts even more difficult, as a processor could never unintentionally divulge either.

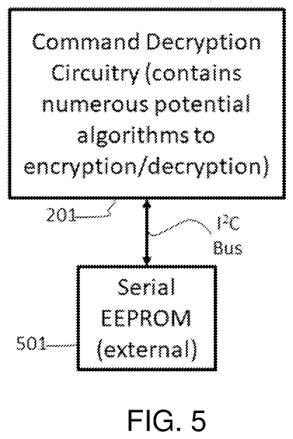

The encryption algorithm may actually be one of several different algorithms, not all of which are used in any one processor. To select which algorithm(s) is used can be done by a number of means. In a typical example shown in FIG. 5, an external serial read-only memory 501 is accessed over a low pin-count serial bus such as the Inter-Integrated Circuit (VC) bus 504 which selects which of the several available algorithms are to actually be used. The serial read-only memory 501 can be programmed at the time a bed of nails tester or other method of verifying the electrical connections in a printed circuit board are verified. Each production unit can have a random selection of which algorithms are used by programming different values in each serial read-only memory 501 during testing. Once programmed, a write inhibit feature prevents further updates to the serial read-only memory 501. The selected algorithms can vary from board to board, which means no one on the ‘inside’ of Printed Circuit Board (PCB) manufacturing environment will know what algorithm is in use on a lot of boards, as each PCB in a lot of PCBs can use a different combinations of algorithms. Thus they could not sell that information to those who would want to engage in a BOA attack on processors from that production run.

In at least one embodiment shown in FIG. 4, not only the instructions intended for the IR 103, but data values that may be written to Internal Processor Registers 106, data values presented to the ALU 107, or data values written to the Flags 108 from addresses pointed to by the program counter are also encrypted and therefore they must also pass through the EDC 301. This embodiment means that the processor does not have to distinguish between instructions that go into the IR 103 versus post-instruction data that go other internal destinations. This requires the use of a second bus 402 that takes the un-encrypted values read from the PMI 105 and passes them to the Internal Processor Registers 106, the ALU 107, or the Flags 108 when the data is part of the instruction itself. The CER 102 will then decide whether to use the decrypted bus 401 or un-decrypted bus 402 to pass data to the Internal Processor Registers 106, the ALU 107, or the Flags 108. Examples of what may be unencrypted would be data or status from IO device, or data repositories in Main Memory 101a so these must pass over the un-decrypted bus 402 to go into an internal destination inside the processor.

Decryption algorithms should minimize any delay, or have no delay placed on the flow of an instruction from Memory 101 to the IR 103. As there may be some delay in the decoding logic, it may be necessary to ‘pipeline’ the instruction and use an additional stage of registers.

During the instruction debugging phase, it may be desirable to disable the EDC 301 so that it does not modify any instruction passing through it. An external pin (not shown in the drawings) on the processor may be used to force the Seed Value in the CER 302 or CER 202 to assume a state that does not encrypt or decrypt instructions. By allowing the signal to float when encryption is to be enabled, or connecting the pin to a low voltage signal such as the ground return signal when encryption is to be disabled, the option to enable or disable encryption is implemented. An optional resistor that is taken out of the bill of materials of a PCB design for production PCBs will provide the needed connection to the ground return line during the debugging phase in a laboratory setting. But by not being inserted for PCBs delivered to customers, the missing resistor ensures that the encryption to stop BOA will be implemented. This is an example of how encryption/decryption can be disabled for code troubleshooting but enabled for production PCBs, however, this method of selectively enabling or disabling encryption by a hardware means does not limit the scope of the claimed subject matter to just this one method.

Two suggested encryption and decryption algorithms are 1) using the Seed Value, invert selected bits in the instruction, and 2) taking groups of four bits in each instruction, use the Seed Value to swap their positions around. Neither algorithm depends on the state of a bit in the instruction to determine the final outcome of another bit in the instruction. Both algorithms preserve the uniqueness of every bit in the instruction so that the instruction can be faithfully reconstructed during decryption, and both algorithms minimize the amount of logic needed to implement them. It will take one bit of a Seed Value for each bit in the instruction to implement the inversion algorithm, and it will take five bits of a Seed Value for each four bits in the instruction to implement the suggested bit swapping algorithm to provide any of the 24 possible combinations when swapping four bits around. For a 32 bit instruction, the two algorithms provide 2³² and 2⁴⁸, respectively, different permutations; combined they provide over 4.7×10²⁰ permutations. Larger instructions will involve even larger numbers of permutations. Due to the slow speed by which feedback back to the malicious user on the success or failure of a particular guess is, the number of permutations from a 32 bit instruction alone will be adequate to discourage all future BOA attacks. For 64 bit instructions, the odds are that the processor itself will wear out long before a malicious hacker could ever stumble across the correct Seed Value and algorithm even if the processor is never reset again.

FIG. 1 depicts an embodiment of the prior art. There is no instruction encryption or Decryption Circuitry in it. It also details an example of a processor implementation that was left out of FIG. 2, FIG. 3, and FIG. 4 for clarity but can be assumed to be present in them.

FIG. 2 depicts an embodiment that requires the Boot Code 101b to generate the random Seed Value for the encryption algorithm and save it in the Command Encryption Register (CER) 202, and for additional files to be saved with the operating system and all other executable files that will inform the processor which locations in the executable files need to be encrypted and which ones do not. With reference to FIG. 2, Internal Processor Bus 104 leads to other destinations (ALU, registers, etc.) for memory content, or post-Instruction processing such as memory address generators).

FIG. 3 depicts an enhanced embodiment of the embodiment in FIG. 2. In this enhanced embodiment the Command Encryption Register 302 (CER) possesses an internal random number generator to create the Seed Value after a reset and keep its contents unknown to the processor. Because the processor cannot read the Seed Value out of the CER 302, it must use the EDC 301 to encrypt instructions before they are written to the Main Memory 101a, and the EDC 301 will also be used to decrypt instructions when the processor must determine if it is the victim of a BOA attack. The EDC 301 in FIG. 3 will also possess numerous possible algorithms, only a small handful will actually be implemented randomly to help further frustrate the efforts of malicious users. With reference to FIG. 3, Internal Processor Bus 104 leads to other destinations (the PMI 105, Internal Processor Registers 106, the ALU 107, or the Flags 108) for memory content, or post-Instruction processing such as memory address generators).

FIG. 4 depicts a more enhanced embodiment of the embodiment in FIG. 3. The additional enhancement provides a means of selected decrypted instructions 401 or selecting unencrypted data 402 from the PMI 105 to load the Internal Processor Registers 106, the ALU 107, or the Flags 108. The selection multiplexor is not shown in FIG. 4, although its function is similar to the Multiplexor 203. The selection between decrypted instructions 401 or un-decrypted data 402 is controlled by the IEC 102. The additional enhancement means that the processor does not need to identify which instructions are intended for the IR 103 and which ones are not during the encryption process while writing the executable code to Main Memory 101a. Therefore no additional files identifying the locations of the instructions intended for the IR 103 are needed, as all instructions and the accompanying immediate data, enhancements to an index register, or extended address values within the instruction stream will be encrypted. With reference to FIG. 4, bus 402 leads to other destinations (the PMI 105, the Internal Processor Registers 106, the ALU 107, or the Flags 108) for Memory 101 content that are not part of the instruction sequence for the processor (i.e., Input or Output accesses, indexed or extended memory accesses); and bus 401 leads to other destinations (the PMI 105, the Internal Processor Registers 106, the ALU 107, or the Flags 108) for memory content that are part of the instruction sequence for the processor.

FIG. 5 depicts a simplified example of a means by which multiple algorithms may exist in the CER 302 each of which would encrypt or decrypt the instructions differently. However, only some of the algorithms are selected for use depending on what is programmed into a serial Electrically Erasable Programmable Read Only Memory 501 (EEPROM) during testing of the PCB that the processor will be placed in. In this example the I²C bus is used to communicate with the Serial EEPROM, although any serial bus designed to minimize the number of signals between the serial EEPROM 501 and the Processor Core may be used.

A novel concept is implemented to modify the bit arrangement and bit states of instructions for a processor with the goal rendering a malicious user unable to execute a successful BOA. In at least one example, the modification technique used can provide more than 4.7×10²⁰ permutations on the changes to the bit arrangement and bit states. Given the slow rate with which a malicious user would get feedback on the success or failure of each attempted BOA, it would take many decades for the malicious user to eventually come to the correct permutation. Each time a processor is reset, a different permutation is typically used. This renders all previous failed attempts of a BOA, which the malicious user would use to indicate the permutations that are invalid, mute, as the new permutation after a reset could be one of those permutations the user previously tried and determined were incorrect.

In some embodiments, all processor instructions written to Main Memory 101a are to be encrypted with the selected permutation, so that when an encrypted instruction is read from Main Memory 101a and decrypted, the instruction will be restored to its original value. To enable this to happen, after reset the processor will not decrypt any instructions while it executes said instructions from a special memory called Boot Code 101b. Boot Code 101b are instructions stored in a non-volatile memory, and having a further attribute that Boot Code 101b is not intended to be changed, unlike code written to a modifiable non-volatile memory such as a disk drive.

The Boot Code 101b will bring the processor and a minimum set of its input/output components to a known operating state after each reset. In one embodiment it will generate a Seed Value for instruction encryption and decryption. The Boot Code 101b will load the instructions for the processor's operating system into Main Memory 101a, encrypting the instructions prior to writing them to Main Memory 101a.

After enough of the operating system has been written to Main Memory 101a for the Boot Code 101b to transfer code execution to Main Memory 101a, the Boot Code 101b executes a command that simultaneously starts executing instructions out of the Main Memory 101a and enables instruction decryption to occur.

Many processors have a special, internal memory called ‘Cache’, which is a volatile memory that is accessed a lot more quickly than Main Memory 101a or Boot Code 101b. The purpose of Cache 101c is to hold the most recently used instructions and data inside the same integrated circuit the processor is in so it can operate faster, as well as freeing up the integrated circuit's External Memory Interface so data can flow into and out of the processor without being slowed down by accesses to frequently used instructions. As such, Cache 101c will contain a copy of the contents of Main Memory 101a or Boot Code 101b that was recently read from or written to.

Prior to executing the instruction to start decryption, much of the Boot Code 101b may be stored in Cache 101c. As this Boot Code 101b in Cache 101c is unencrypted, it must be ‘flushed’ or declared invalid so there will be no further attempt to use it once instruction decryption starts. If decryption starts without doing so, any Boot Code 101b that is accidentally executed will be changed to unintelligible instructions by the decryption process. That could cause the processor to behave erratically, so the Cache 101c contents must be declared invalid to prevent them from being accessed after decryption starts. Only after Cache 101c is re-loaded with encrypted instructions from Main Memory 101a can its contents be reclassified as valid. If the processor operating system deems that it must execute more Boot Code 101b, it must read the Boot Code 101b, encrypt it and then store it in Main Memory 101a for execution just like it would do so for its operating system or any other code that it reads from a disk drive.

If a BOA attack occurs on the processor, the malicious code that will be executed will be rendered unintelligible by the decryption process. Unintelligible code will quickly result in an error event called an ‘exception’. An exception can include errors such as accessing non-existent memory, a lower priority operating state accessing memory or input/output devices reserved for a higher priority state or another process, attempting to write to memory that is write protected, executing an unimplemented instruction, dividing by zero, etc. Once one of these errors occurs, the processor will save its register contents for later analysis and then jump to a higher priority operating state. From this higher priority state the processor will examine the instructions in the Main Memory 101a where the exception occurred and compare them with what should be in that location by reading what was loaded there from the disk drive. If it finds a mismatch, the processor should assume it has suffered a BOA attack and shut down the process that uses that portion of Main Memory 101a and reload it, or if it determines it has suffered multiple BOA attacks or cannot safely shut down that process, the processor resets itself.

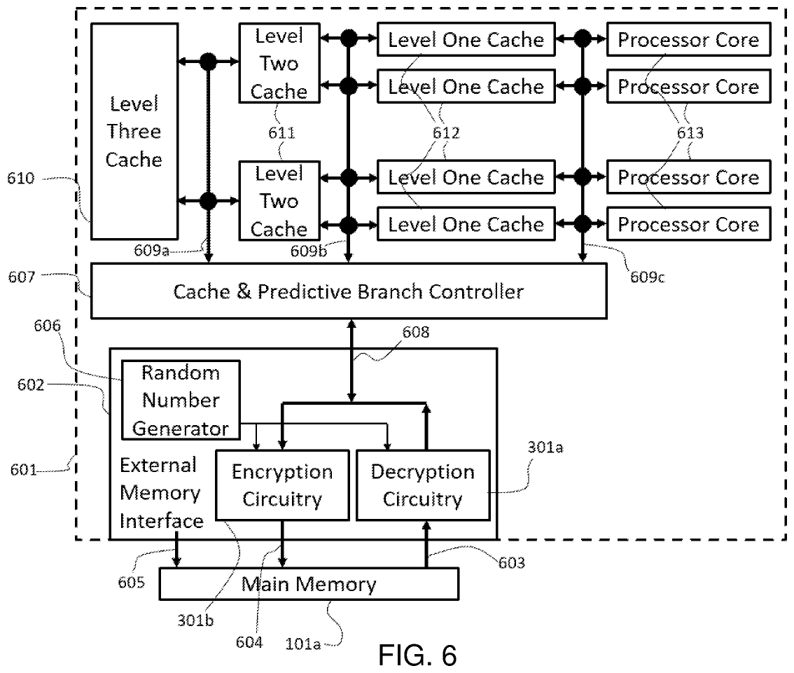

Additional instructions need to be added to the processor to enable the encryption and decryption process to occur. One instruction will be the previously mentioned instruction of beginning to execute encrypted code, which involves transferring program control to another part of memory, turning on the decryption process, and for processors with Cache 101c, declaring the entire Cache 101c (which are all of Cache 610, 611, 612 in FIG. 6) contents invalid.

In an enhanced embodiment, another instruction will be to store an unencrypted value in a register associated with the EDC 301 and read out an encrypted version of it. Another instruction will be to write an encrypted value in a register associated with the EDC 301 and reading out the unencrypted value. These instructions will ease encryption and debugging, and for systems with a Seed Value the processor is not allowed to read, provide the only means of encrypting instructions and examining an area of memory where an exception occurred to determine if the processor has suffered a BOA.

An enhanced embodiment will provide a means of generating a Seed Value for the encryption and decryption process that cannot be read by the processor. This enhances security in that the Seed Value cannot be accidentally disclosed. Note that for debugging purposes it may be necessary to suppress the Seed Value so that there is no encryption or decryption, therefore, the voltage level on an input pin into the processor can allow or deny the processor the ability to use its Seed Value.

Another enhanced embodiment will decrypt not just actual instructions, but any data in the instruction stream such as immediate data, indexed addressing values or extended addresses. This enhanced version does not require the processor to seek out instructions meant only for the IR 103 in the instruction stream to be encrypted while leaving any addressing information or immediate data unencrypted; all can be encrypted.

Another enhanced embodiment will have an encryption and Decryption Circuitry possessing multiple different possible algorithms, with the actual algorithms that will be used by the processor randomly selected during the processor's PCB manufacturing. By assigning a different set of algorithms to each PCB in a PCB lot, it will not be possible for someone intimately familiar with the manufacturing process to be able to sell information as to which algorithms were used for a particular lot of PCBs.

### Solving the Multi-Core Processor BOA

As a further embodiment, of the previous disclosure (including FIGS. 1-5) a novel method of handling the problems posed by having many Processor Cores and predictive branch loading of cache memory when external memory is encrypted is disclosed. The previous disclosures conflicts with the function of a cache & predictive branch controller. All instructions inside the Cache 101c, which in FIG. 6 consist of Level One Cache 612, Level Two Cache 611, and Level Three Cache 610, are encrypted. To enable the cache & predictive branch controller to identify conditional branch and jump instructions, the instructions stored in the Level One Cache 612, and possibly higher levels of Cache 611, 610 need to be decrypted. This requires pushing the instruction decoding and encoding circuits to the Cache Controller 609b between the Level One Cache 612 and the Level Two Cache 611, to the Cache Controller 609a between the Level Two Cache 611 and the Level Three Cache 610, or to the External Memory Interface 602. This further embodiment protects multi-core processor ICs against most Buffer Overflow Attacks (BOAs).

Alternately, the cache & predictive branch controller shares the seed value used to encrypt instructions so that it can read the contents of Level One Cache 612, or possibly also Level Two Cache 611, or possibly also Level Three Cache 610 while they are still encrypted. This enables the cache & predictive branch controller to still seek out both destinations of a branch instruction and place those addresses in the Cache 101c, hopefully even the Level One Cache 612 that is closest to the Processor Core 613, to minimize the number of cache misses that occur.

However, for Return on Program (ROP) or Jump on Program (JOP) BOA, the use of Cache 101c and a cache & predictive branch controllers cannot be used to assist the processor IC in protecting itself against ROP and JOP attacks.

To protect multi-core processor ICs from ROP and JOP attacks, the smaller instructions that are the target of ROP and JOP attacks can be disabled on a per process basis, which shuts down ROP and JOP. Alternately, when a Processor Core does a Return from Interrupt (RTI) or Return from Subroutine (RTS) instruction, the Processor Core will refuse to use whatever is stored in Cache 101c as the cache controller cannot tell which data pulled from stack memory is the return address, so it won't know which one to decrypt. By forcing the cache & predictive branch controller to use Main Memory 101a only for RTS and RTI, or only those Cache 101c where the contents are still encrypted, the external memory controller or the cache and a cache & predictive branch controller can be told which address contains encrypted return address of the Program Counter and decrypts it coming into the processor, which then provides the decrypted return address for the program counter.

User data that is privileged is protected from unauthorized accesses while stored in mass storage devices by a powerful encrypted algorithms such as AES-256, its equivalent, or better. But when it is loaded into a computer's memory that protection goes away. To protect privileged information in Main Memory 101a (and possibly any cache where privileged data may still reside) the same techniques used to encrypt instructions are used to encrypt user data. Each process handling privileged data will have its own encryption key that is passed to an encryption and decryption circuit used to encrypt data being written to memory, or decrypt it when it is read into the processor the process is running on. When the process is through using the data it will delete the encryption key that is unique to the data, instruct the cache and a cache & predictive branch controller to declare those parts of Cache holding such data to declare those locations invalid, and instruct the MMU to overwrite such data in Main Memory 101a.

### Background for the Multi-Core Processor Solution

As previously described, said invention describes the problem of how buffer overflow attacks (BOAs) threaten to install malicious software disguised as data into the Main Memory 101a of a processor with the intent get the code to run and thus compromise the processor). Main Memory 101a is read/writable memory (often called Random Access Memory, or RAM) where both data and instructions co-exist. The BOA attempts to write so much data into the processor that it overflows the boundaries set up for the data buffer in Main Memory 101a, with the malicious data subsequently overflowing the buffer boundaries set up for it and ends up being written into Main Memory 101a set aside for instructions that the processor executes.

Attempts to use protective software alone to solve this problem have failed to completely mitigate the problem. Today it is a multi-hundred million dollar industry attempting to stay ahead of all the different ways malicious users take control of processors. And it consumes a significant percentage of a processor's computing capacity to run this still ineffective software. This increases data costs in terms of more processors needed to provide the computing power to do the job, power consumption needed to provide the additional processors plus the additional energy required of air conditioners to cool the additional processors, and floor space for the additional processors which translates into bigger building costs in multiple categories.

The solution to this problem is to install additional hardware in the processor that disguises the software the processor executes, encrypting it with a simple algorithm that is difficult to guess for hackers because of a near complete lack of feedback on the success of their attempts to do so (referred to as “zero feedback”), and the sheer size of the encryption key. As processor instructions were read from Main Memory 101a they were decrypted just before execution. The decryption process is not written back to memory, which means the same instructions were kept encrypted in memory and had to be decrypted each time they were executed.

This was by design, as once the decryption process was started, nothing short of a processor reset would turn it off. The goal was to make the processor as secure as possible, which means it must continue decrypting instructions indefinitely once started.

This solution works extremely well for processors with a single core, or a small handful of cores. However, each Processor Core has to have an implementation of the encryption and decryption logic within it. When large numbers of cores exist inside a processor, to place a copy of this circuitry inside each core increases the power consumption of the Processor Core, and the complexity (and hence the costs) of the same processor IC. Clearly, a better way of encrypting and decrypting instructions inside a processor IC with a large number of cores is needed.

Another problem arises with any processor Integrated Circuit (IC) containing cache memory that uses predictive branching. A cache memory is a small local memory placed inside the processor IC that can be accessed more swiftly than Main Memory 101a, reducing the number of processor clock cycles that the processor must delay, or “wait” for the instruction to reach the processor. The higher end processors with faster clock speeds and more cores will have multiple levels of cache, with the closest cache to a Processor Core, typically called the Level One Cache, is usually the smallest, but most quickly accessible local cache memory. Typically each Processor Core will have its own dedicated Level One Cache or shares the Level One Cache with a very small number of other cores. In general, a Level One Cache can be accessed with zero wait states.

Larger numbers of cores will share a larger but slightly slower Level Two Cache, typically with more wait states than a Level One Cache but still fewer than Main Memory 101a. And in the largest processor ICs, there would be an even larger, but also slower, Level Three Cache typically (but not always) accessible by all cores in the processor, or a few Level Three Cache such that all cores in the processor have access to a Level Three Cache. It will typically have more wait states than a Level Two Cache, but still fewer wait states than having to access the same instructions from Main Memory 101a. Other implementations may have more levels of cache or fewer levels of cache, what is described herein is intended as an example only and not intended to limit the scope of the claims.

The job of a cache memory is to carry an identical copy of an instruction or data kept in Main Memory 101a. This creates management complexities, in that when a Main Memory 101a content changes, then the copy carried inside the cache in the processor IC is no longer valid and must be refreshed. This problem has already been solved by various means and is beyond the scope of this disclosure, but is only mentioned here to ascertain that the inventor is aware of the problem and that it has been solved.

Among other things, predictive branching is the process that a cache memory controller performs by going through the contents of the cache that the Processor Core is executing out of, looking for the next “conditional branch” instruction. A conditional branch is an instruction that goes to one section of memory if a test condition is true, or else it continues with the next instruction in sequence if the test condition is not true. For example, if the previous mathematical operation resulted in a value of zero, then a “branch if zero” instruction will cause the processor to execute code from a different area of memory rather than the next instruction in sequence. Predictive branching will attempt to determine where the new location the processor jumps to will be and ensure its contents are in cache, as well as the next instructions past the conditional branch instruction, so that no matter whether the processor branches or continues with the next instruction in sequence, both will be in the cache and therefore the processor will not have to wait for Main Memory 101a to be accessed to continue.

If the instructions stored in Cache 101c remain encrypted, the controller that executes the predictive branching session will be unable to identify the branch instruction, and thus not be able to make attempts to keep the potential destinations of the branch resident in cache.

### Description of the Multi-Core Processor BOA Solution

A way to get around these problems is to place both the encryption and Decryption Circuitry of the invention in the External Memory Interface(s) of the processor IC rather than in each Processor Core inside the processor IC, or to place it between the Level One Cache and the Level Two Cache, or between the Level Two Cache and the Level Three Cache, such that the contents of at least the Level One Cache are not encrypted.

There should be more than one instance of the Decryption Circuitry and at least one instance of the encryption circuitry at each External Memory Interface. Data rates for External Memory Interfaces may be too fast for a single instance of the decryption circuit 201b to be able to keep up with the incoming data. Therefore, multiple instances of each circuit need to exist in the memory interface. These multiple instances of the Decryption Circuitry would accept a single data transfer on a sequential basis; that is, one decryption circuit 201b would accept one data transfer, the next decryption circuit 201b in line gets the next data transfer, etc. until the first one has had time to complete the decryption process and pass it on to a buffer that can present it to the rest of the processor IC. Once the decrypted instruction is passed from the Decryption Circuitry, the first decryption circuit 201b is ready to accept a new data transfer, starting the process all over again. Control of these decryption circuits can be done with a token passing scheme or a round-robin controller that continuously cycles through all of the decryption circuits. If no data is available the selected decryption circuit 201b stays idle and doesn't accept anything off of the external data bus. If available, the decryption circuit 201b accepts the data and however many clock cycles later that it takes to complete the decryption process presents the decrypted data to the rest of the processor IC.

Staying with each data word that is decrypted is the fetch completion information. The fetch completion information is not changed as the data word is decrypted. The use of the fetch completion information may change from one processor IC architecture to another, but in general it contains information on which Processor Core, and if multi-threaded, which processor thread within the core, requested the data.

This is true whether there are only a few Processor Cores or many Processor Cores (even over a hundred Processor Cores) in the processor IC.

It is not necessary for each memory interface to share the same random number used to encrypt and decrypt the instructions with each other. As each External Memory Interface is physically and electrically separated from each other, there will not be the problem of one memory interface attempting to decrypt a memory location encrypted by a different encryption key from another memory interface. Therefore, each memory interface may have its own Random Number Generator (RNG) if that is more expedient in adding the encryption and decryption circuit 201b to each one when there are more than one memory interfaces on a processor IC. Alternately, if it is easier to install an RNG common to several or all External Memory Interfaces the designer(s) of the processor IC may do so.

Any Main Memory 101c location accessed by the program counter 106a of a Processor Core 613, or by the predictive branching operation, must be decrypted before it enters the cache or the Processor Core that needs it. Thus, the External Memory Interface 602 will be notified by the Processor Core 613 or by the cache & predictive branch controller that the memory location needs to be decrypted before being sent to the core or the cache memory. This way all instructions inside the processor IC are decrypted when they reach the core itself, and the Decryption Circuitry does not have to reside in any of the Processor Cores 613 anymore.

This solution also requires that the encryption circuitry reside in the External Memory Interface 602. When a processor wants to load a new program into Main Memory 101c (for example, a web browser, a word processor, or a spreadsheet) instead of writing the instructions directly to Main Memory 101c, the processor would write them to an Input/Output (IO) port at the External Memory Interface 602, along with the address where the instruction is to be stored in Main Memory 101c. The IO port encrypts the instruction, and then the External Memory Interface 602 does the actual writing of the encrypted instruction into Main Memory 101c.

An alternate solution is to place the Decryption Circuitry in the cache & predictive branch controller Interface 609b between Level One Cache 612 and Level Two Cache 611, or in the cache & predictive branch controller Interface 609a between Level Two Cache 611 and Level Three Cache 610. The encryption of instructions being stored in Main Memory 101c would still reside in the External Memory Interface 602.

### ROP and JOP Vulnerabilities

However, this process makes it difficult to handle the problem of a BOA known as Return on Program (ROP) and Jump on Program (JOP). ROP and JOP attacks are attacks created by malicious users who go through commonly used set of 32 bit or 64 bit instructions found in most processors such as the operating systems (OS) or mathematical libraries. The malicious users' goal is to find 8 bit or 16 bit instructions that were unintentionally created as part of a 32 bit or 64 bit instruction. While not intended to be instructions of their own by their original authors, they will be interpreted as such if the program counter were to jump to the 2nd or later byte of a 32 bit or 64 bit instruction. When they are strung together they create new programs that can compromise processor integrity. The malicious user then has to trick the processor into jumping directly to the address of these 8 and 16 bit instructions rather than the address of 32 bit or 64 bit instruction they were part of.

Normal processor operations will never access these memory locations as 8 or 16 bit instructions. However, when a processor executes a subroutine or an interrupt, the program counter value is pushed, or stored in data memory in what is known as the stack, which is a section of memory pointed by a stack pointer for the storage of temporary values useful to the program execution. Some buffer overflow attacks will overwrite data stored on the stack, and this includes the return address of the processor. This will point it to a ROP or JOP address, compromising the processor as a result. To mitigate this, the existing invention also encrypts all writes of the program counter to Main Memory 101a, such as during an interrupt or subroutine call, and decrypts the return address before restoring it to the program counter. If the location on the system stack where the program counter was stored is over-written by a malicious user during a buffer overflow attack to point to where a ROP or JOP attack can take place, it will be modified by the decryption process and thus not point to the offending location anymore.

The problem with placing the decryption process at the External Memory Interface 602 of a processor IC, instead of inside each Processor Core itself, is that the cache controller cannot figure out which location on a stack is the return address of the program counter. As such it cannot tell the External Memory Interface to decrypt what should be the return address. Any return address will have to be placed in cache memory as is, making a multi-core processor IC vulnerable to ROP and JOP attacks again.

### ROP and JOP Solutions

There are two possible solutions to this problem.

A solution to the ROP and JOP attacks is to disable all 8 and 16 bit instructions in a 32 bit or 64 bit processor, and if processors progress beyond 64 bits, possibly disable 32 bit instructions separately as well. There should be a means of disabling 8 and 16 bit instructions, and another means of disabling 32 bit instructions when processors progress beyond 64 bit data busses. However, such a drastic solution will be strongly opposed by the software community as many of the 8 and 16 bit instructions are quicker to execute and take less memory space than a 32 bit or larger instruction meant to do the same thing. A possible compromise would be to allow each processor session to be able to re-enable these shorter instructions while the session is running, and when the session is not running, they are disabled again until another session (or the same session starts again) and enables them for itself. Note that enabling the smaller instructions does leave the core vulnerable to ROP and JOP attacks and must be done only when essential.

When this option is implemented, a flag needs to be saved for the session that enables these instructions. This way if the session gets interrupted, these instructions will be disabled for the interrupt. They are then automatically re-enabled when the session continues from an interrupt and the flag is pulled back into the process' control register re-enabling them. Note that at the moment the interrupt is acknowledged the 8 & 16 bit opcodes must be disabled, as the interrupt procedure will assume this and thus not realize it would be vulnerable to ROP and JOP if that were not the case.

The Other Way of Solving the Problem is this:

Any time the program counter is pushed onto the system stack, which is what happens during a subroutine call or during an interrupt, the Processor Core informs the External Memory Interface 602 that it will use the encrypting IO port to do so. The program counter's current value is sent to the encrypting IO port along with the address of the location on the system stack where it will be stored. The IO port then proceeds to write the encrypted program counter value to Main Memory 101a. When the return from interrupt (RTI) or return from subroutine (RTS) instruction is then executed, the Processor Core 613 informs the External Memory Interface 602 that it will not accept a cached value for the return address of the program counter, therefore the External Memory Interface 602 will have to fetch the return address from Main Memory 101a and decrypt it, or have the cache & predictive branch controller do so if that is where the Decryption Circuitry exists. This will slow the processor down, but these instructions are not executed very frequently at all, unlike instructions in a loop that can be executed a dozen to hundreds or even thousands of times and can be executed quickly when pulled from cache.

This second option is the most secure, and requires different hardware to implement than the option to disable 8 & 16 bit opcodes. Both options could co-exist in a processor IC, although if option 2 exists it makes no sense at all to be able to implement option 1. Option 2 will slow the core down slightly, but since this is rare event in code execution, the impact will be insignificant. And the time consumed having to pull a return address from Main Memory 101a may be partially made up by not having to execute an instruction to enable or disable 8 and 16 bit instructions.

Note that the option to not accept a cached value for a certain memory location read is already implemented in many processor ICs so they can deal with deterministic processes. There is a certain variability in fetching something from Cache 101c vs. Main Memory 101a that can make deterministic processes less deterministic. By not accepting a cached value, the variability is reduced. Therefore, in most instances of processor IC designs, very little additional hardware gates (multiple transistors combined together correctly correspond to a gate) will have to be added to implement the 2nd ROP & JOP protection option, as most of the gates already exists for other reasons.

### Implementation Multi-Core Processor BOA Solution

Notes for the following sections in this disclosure: Main Memory 101a, Decryption Circuitry 301b, and Encryption Circuitry 301a reside in FIG. 6 when referenced in the description below. All other numbered references will be with the figure the reference number would normally be kept in, i.e., the first digit of the reference number is the figure number.

Referring to FIG. 6 below, the encryption and Decryption Circuitry 301 that would reside inside the Processor Core (the Processor Core with the encryption and Decryption Circuitry in it consists of all of FIG. 3 except external memory 101a and 101b of FIG. 1) is now moved to the External Memory Interface 602. Note that the terms “External Memory” encompasses both Main Memory 101a and boot code 101b. Only the Main Memory 101a will be used going forward in this disclosure.

FIG. 6 depicts a partial block diagram of a processor integrated circuit 601 (IC) with multiple Processor Cores 613. More specifically, FIG. 6 depicts an example of a four Processor Core 613 implementation of a processor IC 601, with each Processor Core 613 having its own Level One Cache 612, and each Level Two Cache 611 being shared among two Level One Cache only. This is meant to be an example of the implementation only and is not intended to restrict the application of the invention to this architecture only, to the number of Processor Cores 613, or to the number of different types of cache memories 101c or how they connect to each other.

In the processor IC 601 with multiple Processor Cores 613 in it, encryption takes place when any Processor Core 613 writes to the encryption circuitry 301a. The encryption process will also take place automatically if the processor IC design includes the option of writing any storage of the program counter 106a on a stack during a subroutine call or the acknowledgement of an interrupt to the encryption circuitry 301a by any of the Processor Cores.

The encryption circuitry 301a encrypts the data written to it by the Processor Core 613 and then the encryption circuitry 301a writes the data to the Main Memory 101a over the external memory data bus 604 and control and address bus 605.

In most processor IC 601 implementations the write data bus 604 and the read data bus 603 are the same bus, but for easier illustration they are shown separately. The claims of this disclosure are applicable to either, however. Both will use the control and address bus 605 to access external memory.

The description in the implementation described herein consists of cache memories 101c (see FIG. 1), consisting of a Level One Cache 612, possibly a Level Two Cache 611, and possibly a Level Three Cache 610. How they interact with the external memory controller 602 in this description is an example and is not meant to restrict the scope of this invention to this particular implementation only. It is provided only as a means of showing how the implementation of the invention may interact with Cache 101c and multiple Processor Cores 613 inside a processor IC. The implementation of this invention may involve fewer levels of Cache memories 101c or more levels of cache memories 101c than what is shown in FIG. 6.

The method of initially loading encrypted instructions in Main Memory 101a is the same as previously described in the invention's claims 1 through 18. After a processor IC 601 reset, the random number generator 606 develops a seed number that is used by the encryption circuitry 301a in the External Memory Interface 602 to encrypt the instructions as they are written to Main Memory 101a, and the Decryption Circuitry 301b uses the same seed number to decrypt the instruction. Once decryption is enabled by a Decrypt Command 205, the decrypt latch 206 is set and from this point forward the cache & predictive branch controller will always inform the External Memory Interface 602 to pass instructions through the Decryption Circuitry 301b before storing in any local cache 101c, which consists of a Level One Cache 612, possibly a Level Two Cache 611, and possibly a Level Three Cache 610, or even higher levels of cache, which could exist but are not in FIG. 6 for clarity. This invention is not limited in scope to processor ICs 601 of three level of cache or less only.

How the processor IC 601 tells the difference between writes to Main Memory 101a that must be encrypted and those that bypass the encryption is dependent upon the internal implementation of the processor IC 601 designers. In this example it will be assumed that a “Pre Opcode” instruction executed inside each Processor Core 613 precedes the actual write instruction, which means the data to be written will be encrypted by the encryption circuitry 301a, and when the write instruction is not preceded by said “Pre Opcode” instruction, the data to be written passes through (or it may bypass) the encryption circuitry 301a without being encrypted. Other methods of using or bypassing the encryption circuitry 301a are also valid, this invention is not limited in scope to using a “Pre Opcode” as the only mechanism to do so. Other valid methods are to have a separate set of instructions for this particular purpose or setting a bit in a control register, but again this does not limit the scope of this invention.

### The Purpose of Cache Memory

In the example, the Processor Core 613 does not directly fetch an instruction from Main Memory 101a. Instead, it presents to the cache & predictive branch controller the address of the needed instruction. If a copy of the instruction exists in the Level One Cache 612 then the instruction passes directly to the Processor Core 613 for execution.

If the instruction doesn't reside in the Level One Cache 612, but it exists in the Level Two Cache 611 that can feed the Level One Cache 612 associated with the Processor Core 613 accessing it, then it is fetched from the Level Two Cache 611. Over the direct connection bus 609b the instruction is sent directly to the Processor Core 613 over the bus 609c through the cache & predictive branch controller. A copy of the instruction is also saved in the Level One Cache 612 as well.

If a copy of the instruction doesn't exist in the Level Two Cache 611 but does in the Level Three Cache 610, a similar process occurs, only it involves all the cache 610, 611, 612 and the busses 609a, 609b, 609c that feed instructions or data to the Processor Core, and typically with an even longer delay to get the instruction to the Processor Core 613.

If the instruction does not reside in any cache 610, 611, 612, then the cache & predictive branch controller sends a command to the External Memory Interface 606 to fetch the instruction from Main Memory 101a while also informing the External Memory Interface 602 that it must decrypt the instruction before sending it to the cache & predictive branch controller by passing it through the Decryption Circuitry 301b in the External Memory Interface 602. Included in the command to the External Memory Interface will be the fetch information, such as the Processor Core 613 requesting the data and the thread within said Processor Core if such a thread exists.

### The Quantity of Decryption Circuits 301b

During the decryption process, the number of decryption circuits 301b needed will vary with the speed with which data can be read from the External Memory Interface 602. Depending on the complexity of the encryption and decryption algorithms, the time needed for an encrypted instruction to be decrypted by the Decryption Circuitry 301b may exceed the arrival time of subsequent encrypted instructions from Main Memory 101a. To prevent overflowing the decryption process, multiple decryption circuits 301b shall be present. Processor ICs 601 where power consumption is at a premium, such as those used for laptop computers, will generally contain slower and fewer Main Memory 101a interfaces 602, and because the Main Memory 101a interface 602 will be slower, it will contain fewer decryption circuits 301b that a faster Main Memory 101a interface 602. In general, slower External Memory Interfaces 602 will consume less power than faster External Memory Interfaces 602.

With multiple idle decryption circuits 301b, when presented with an encrypted word, one will accept a token and begin the decryption process, and with the next data to be decrypted arriving before the now active decryption circuit 301b is completed with the existing data's decryption. Therefore, the token generated for the next encrypted word arriving will be accepted by the next decryption circuit 301b that is idle. Once a decryption circuit 301b is complete with the decryption process and has passed on the decrypted word along with the fetch completion information for said word, it can accept a token again for the next incoming word needing decryption. In lieu of tokens, a simple controller will sequence from decryption circuit 301b to decryption circuit 301b, one at a time. If the selected decryption circuit 301b finds data from the Main Memory 101a is present, it will accept the data and begin the decryption process. By the time the sequencer gets around to it again the decryption circuit 301b will have completed the decryption process and be ready to accept the next data to be decrypted.

### Predictive Branching

As all instructions residing in the cache 612, and possibly 611, 610 are decrypted, the cache & predictive branch controller is able to monitor instruction requests from each Processor Core 613 over the bus interface 609c and search ahead for branch instructions. Alternately, if the instructions saved in Cache 101c remain encrypted, then the cache & predictive branch controller will be able to decrypt them for the purposes of searching for conditional branches. When it finds one, it determines all of the ways the instruction stream can go and attempts to store in the associated Level One Cache 612 instructions from any branch decision so as to minimize the waiting, otherwise known as a cache miss, that the Processor Core 613 must endure before receiving the next instruction.

### Implementing the ROP and JOP Solution

As mentioned in the ROP and JOP Solution section above, there are two possible solutions this invention may use to solve the ROP and JOP vulnerabilities caused by moving the encryption and Decryption Circuitry 301 out of the Processor Core 613.

To implement the 1st solution, a bit is added to the flags 108. This additional bit controls whether the 8 & 16 bit instructions are enabled or disabled. These instructions default to being disabled after decryption instruction command 206 begins, and must be enabled by a command executed by the Processor Core 613. Once enabled, the instructions are only enabled until the next interrupt or until the process disables them again. The flags 108 with the bit controlling the 8 & 16 bit instructions being enabled or not is saved on a system stack where the different processes are kept. After saving the flags 108, the 8 & 16 bit instructions are automatically disabled again. If the interrupt needs them enabled it will do so by setting the enable bit for them. Upon completion of the interrupt the Return from Interrupt (RTI) command is executed. The flags 108 for the process are restored, including the bit that enables or disables the 8 & 16 bit opcodes. If Processor Cores 613 larger than 64 bits becomes a reality, then the same bit or a separate bit can enable or disable 32 bit instructions as well, with the default being disabled after decryption is started.

The second solution is more secure. Upon detecting an attempt to load the program counter 106a while executing a Return from Interrupt (RTI) or Return from Subroutine (RTS), the Processor Core 613 will inform the cache & predictive branch controller that it will not accept a value stored in any cache 101c, whether it is in Level One Cache 612, Level Two Cache 611, Level Three Cache 613 or even beyond if more than three levels of cache 101c exist in the processor IC 601. The cache & predictive branch controller will go to the External Memory Interface 602 and request the return address be read from Main Memory 101a and get it decrypted. After decryption this value is sent to the Processor Core 613 to be loaded into its program counter 106a, completing the RTI or RTS instruction. The ability to tell the cache & predictive branch controller to not accept a value stored in any cache 101c already exists in processors since that helps making certain delays more deterministic.

### Acknowledgements

The inventor wishes to acknowledge Jack Arnold Shulman of Westfield, New Jersey for engineering contributions to the wording of the background section in paragraph [0005] as well as in claim 26, which while conceived by the inventor and his engineer was originally not as comprehensive as it could have been, and Edward Reed Brooks of Plano, Texas for his gracious support, facilitation, and administrative assistance in this effort.

What is claimed is:

1. A processor implemented within a multicore processor integrated circuit (IC), the processor comprising:
an instruction register; and
selection circuitry comprising a hardware latch operable to thwart a buffer overflow attack, wherein:
the selection circuitry is electrically coupled with the instruction register; and
the selection circuitry is configured for: providing decrypted instructions to the instruction register when the hardware latch is in a first state; and
providing un-decrypted instructions to the instruction register when the hardware latch is in a second state.

2. The processor of claim 1, wherein the hardware latch is set to the first state upon receiving a decrypt command.

3. The processor of claim 2, wherein the hardware latch is set to the second state upon the processor exiting a reset.

4. The processor of claim 1, wherein selection circuitry further comprises:
a multiplexor having a first input for receiving decrypted instructions;
a second input for receiving un-decrypted instructions; and
an output electrically coupled with the instruction register.

5. The processor of claim 1 further comprising a memory interface and the memory interface is configured for coupling to one or more memories, wherein the one or more memories are configured to store boot code instructions, unencrypted instructions, and encrypted instructions.

6. The processor of claim 5, wherein un-decrypted instructions include at least one of the boot code instructions and the unencrypted instructions.

7. The processor of claim 5, wherein the selection circuitry is further configured to receive the un-decrypted instructions from the memory interface.

8. The processor of claim 7 further comprising encryption/decryption circuitry, wherein:
the encryption/decryption circuitry is electrically coupled between the memory interface and the selection circuitry; and
the encryption/decryption circuitry is configured for:
receiving the encrypted instructions from the memory interface; and
decrypting the encrypted instructions to provide the decrypted instructions to the selection circuitry.

9. The processor of claim 8, wherein the encryption/decryption circuitry is further configured for:
receiving the unencrypted instructions from the memory interface; and
encrypting the unencrypted instructions to provide the encrypted instructions to the one or more memories via the memory interface.

10. The processor of claim 9, wherein encrypting the unencrypted instructions is based on a seed value and a built-in algorithm.

11. The processor of claim 10, wherein the data encryption and decryption circuits used to implement the encryption and decryption of instructions for the processor core inside a processor IC are removed from all the processor cores in a multicore processor IC and placed in the External Memory Interface or inside the interface between the cache memories closest to each processor core and the next level up, the purpose for which is to:
reduce the frequency with which these circuits occur inside the processor IC, to reduce the heat generated by their presence;
reduce the frequency with which these circuits occur inside the processor IC, to reduce the number of gates consumed by the processor IC;
allow the internal cache of the processor to only have decrypted instructions residing in it so that an intelligent cache controller, such as a cache and predictive branch controller, is able to go through instructions stored in cache that are frequently being executed by a processor core and recognize conditional branch instructions and attempt to place instructions starting at any location the conditional branch could direct the processor core's program counter could go to, the goal of which is to minimize cache misses, that is, asking for an instruction that is not in cache and therefore requires the processor core to endure wait states until the instruction is brought to it from elsewhere; and
further since the decryption circuits are only used when bringing in new instructions from a memory external to the processor IC or from a cache more distant from the processor core than the closest cache, whenever a processor core executes the same set of already decrypted instructions over and again while executing instruction loops out of cache, as the instructions are already decrypted in the cache memory or closest cache memory, the decryption circuits can remain idle and thus generate even less heat than if the circuits were inside each processor core.

12. The processor of claim 11, wherein the cache and predictive branch controller cannot tell which memory location is used to store the return address of the program counter, if said external memory location is unencrypted then by optionally disabling 8 and 16 bit instructions in 32 bit or larger processor cores, then optionally disabling 32 bit instructions in processor cores using instruction widths that are 64 bits or larger, these smaller instructions being the target of malicious users who attempt to change the return address to point to a series of smaller instructions that are incidentally embedded as parts of larger instructions in commonly used programs loaded in memory that can compromise a computing system, the attempt by a malicious user to execute these instructions is thwarted, preventing the compromising of the security of a computer system.

13. The processor of claim 12, when the program counter is stored on a stack during the execution of a subroutine call or the acknowledgement of an interrupt, the value stored on the system stack is not encrypted as the cache and predictive branch controller, which controls all processor core accesses to external memory, is unable to determine which memory location in external memory pointed to by a stack pointer contains the program counter return address.

14. The processor of claim 12, wherein the cache and predictive branch controller cannot tell which memory location is used to store the return address of the program counter, if said memory location is encrypted, then when restoring a processor core's program counter during a return from interrupt or return from subroutine, the processor core informs the cache and predictive branch controller that it will not accept any content that happens to reside in cache or cache sub frame, due to impurity caused by the undecrypted program counter return address, thus faulting and invalidating the cache sub frame, or the entire cache, depending on the cache's implementation choice and style, thereby forcing the cache and predictive branch controller to go to the external memory interface to access the return address, and that when the external memory location is accessed, its contents shall be decrypted before being sent to the processor core.

15. A method implemented on a processor comprising an instruction register and selection circuitry comprising a hardware latch, the method comprising:
providing decrypted instructions to the instruction register from the selection circuitry when the hardware latch is in a first state; and
providing un-decrypted instructions to the instruction register from the selection circuitry when the hardware latch is in a second state, wherein:
the hardware latch is operable to thwart a buffer overflow attack on the processor; and
the processor is implemented within a multicore processor integrated circuit (IC).

16. The method of claim 15, wherein the hardware latch is set to the first state upon receiving a decrypt command.

17. The method of claim 16, wherein the hardware latch is set to the second state upon the processor exiting a reset.

18. The method of claim 15, wherein selection circuitry further comprises:
a multiplexor having a first input for receiving decrypted instructions;
a second input for receiving un-decrypted instructions; and
an output electrically coupled with the instruction register.

19. The method of claim 15, wherein:
the processor further comprises a memory interface and the memory interface is configured for coupling to one or more memories; and
the one or more memories are configured to store boot code instructions, unencrypted instructions, and encrypted instructions.

20. The method of claim 19, wherein the undecrypted instructions include at least one of the boot code instructions and the unencrypted instructions.

21. The method of claim 19, wherein the selection circuitry is further configured to receive the un-decrypted instructions from the memory interface.

22. The method of claim 21, wherein the processor further comprises encryption/decryption circuitry, wherein:
the encryption/decryption circuitry is electrically coupled between the memory interface and the selection circuitry; and
the encryption/decryption circuitry is configured for:
receiving the encrypted instructions from the memory interface; decrypting the encrypted instructions to provide the decrypted instructions to the selection circuitry;
receiving the unencrypted instructions from the memory interface; and
encrypting the unencrypted instructions to provide the encrypted instructions to the one or more memories via the memory interface.

23. The method of claim 22, wherein the data encryption and decryption circuits used to implement the encryption and decryption of instructions for the processor core inside a processor IC are removed from all the processor cores in a multicore processor IC and placed in the external memory interface, the purpose for which is to:
reduce the frequency with which these circuits occur inside the processor IC, to reduce the heat generated by their presence;
reduce the frequency with which these circuits occur inside the processor IC, to reduce the number of gates consumed by the processor IC;
allow the internal cache of the processor to only have decrypted instructions residing in it so that an intelligent cache controller, such as a cache and predictive branch controller, is able to go through instructions stored in cache that are frequently being executed by a processor core and recognize conditional branch instructions and attempt to place instructions starting at any location the conditional branch could direct the processor core's program counter could go to, the goal of which is to minimize cache misses, that is, asking for an instruction that is not in cache and therefore requires the processor core to endure wait states until the instruction is brought to it from elsewhere; and
further since the decryption circuits are only used when bringing in new instructions from a memory external to the processor IC, whenever a processor core executes the same set of already decrypted instructions over and again while executing instruction loops out of cache, as the instructions are already decrypted in the cache memory, the decryption circuits can remain idle and thus generate even less heat than if the circuits were inside each processor core.

24. The method of claim 23, wherein the cache and predictive branch controller cannot tell which memory location is used to store the return address of the program counter, if said external memory location is unencrypted, then by optionally disabling 8 and 16 bit instructions in 32 bit or larger processor cores, and optionally disabling 32 bit instructions in processor cores using instruction widths of 64 bits or larger, these smaller instructions being the target of malicious users who attempt to change the return address to point to a series of smaller instructions that are incidentally embedded as parts of larger instructions in commonly used programs loaded in memory that can compromise a computing system, the attempt by a malicious user to execute these instructions is thwarted, preventing the compromising of the security of a computer system.

25. The method of claim 24, when the program counter is stored on a stack during the execution of a subroutine call or the acknowledgement of an interrupt, the value stored on the system stack is not encrypted as the cache and predictive branch controller, which controls all processor core accesses to external memory, is unable to determine which memory location in external memory pointed to by a stack pointer contains the program counter return address.

26. The method of claim 23, wherein the cache and predictive branch controller cannot tell which memory location is used to store the return address of the program counter, if said memory location is encrypted, then when restoring a processor core's program counter during a return from interrupt or return from subroutine, the processor core informs the cache and predictive branch controller that it will not accept any content that happens to reside in cache or cache sub frame, due to impurity caused by the undecrypted program counter return address, thus faulting and invalidating the cache sub frame, or the entire cache, depending on the cache's implementation choice and style, thereby forcing the cache and predictive branch controller to go to the external memory interface to access the return address, and that when the external memory location is accessed, its contents shall be decrypted before being sent to the processor core.
